(19) United States
(12) Patent Application Publication
(10) Pub. No.: US 2012/0125643 A1
(43) Pub. Date: May 24, 2012

(54) PROCESS FOR MINERAL OIL PRODUCTION USING HYDROPHOBICALLY ASSOCIATING COPOLYMERS

(75) Inventors: Björn LANGLOTZ, Trostberg (DE); Roland Reichenbach-Klinke, Traunstein (DE)

(73) Assignee: BASF SE, Ludwigshafen (DE)

(21) Appl. No.: 13/303,649

(22) Filed: Nov. 23, 2011

Related U.S. Application Data
(60) Provisional application No. 61/416,753, filed on Nov. 24, 2010.

(51) Int. Cl. E21B 43/16; C08F 228/02

(52) U.S. Cl. 166/400; 526/287

(57) ABSTRACT

A process for mineral oil production, in which an aqueous formulation comprising at least one water-soluble, hydrophobically associating copolymer is injected through at least one injection borehole into a mineral oil deposit, and crude oil is withdrawn from the deposit through at least one production borehole, wherein the water-soluble, hydrophobically associating copolymer comprises at least acrylamide or derivatives thereof, a monomer having anionic groups and a monomer which can bring about the association of the copolymer, and water-soluble, hydro-phobically associating copolymer which has a low shear degradation and is suitable for execution of the process.

The present invention relates to a process for mineral oil production, in which an aqueous formulation comprising at least one water-soluble, hydrophobically associating copolymer is injected through at least one injection borehole into a mineral oil deposit, and crude oil is withdrawn from the deposit through at least one production borehole, wherein the water-soluble, hydrophobically associating copolymer comprises at least acrylamide or derivatives thereof, a monomer having anionic groups and a monomer which can bring about the association of the copolymer. The invention further relates to a water-soluble, hydrophobically associating copolymer which has only a low shear degradation and has particularly good suitability for execution of the process.

In natural mineral oil deposits, mineral oil is present in the cavities of porous reservoir rocks which are sealed toward the surface of the earth by impermeable top layers. The cavities may be very fine cavities, capillaries, pores or the like. Fine pore necks may, for example, have a diameter of only approx. 1 μm. As well as mineral oil, including fractions of natural gas, a deposit also comprises water with a greater or lesser salt content.

In mineral oil production, a distinction is drawn between primary, secondary and tertiary production.

In primary production, after commencement of drilling of the deposit, the mineral oil flows of its own accord through the borehole to the surface owing to the autogenous pressure of the deposit. The autogenous pressure can be caused, for example, by gases present in the deposit, such as methane, ethane or propane. The autogenous pressure of the deposit, however, generally declines relatively rapidly on extraction of mineral oil, such that usually only approx. 5 to 10% of the amount of mineral oil present in the deposit, according to the deposit type, can be produced by means of primary production. Thereafter, the autogenous pressure is no longer sufficient to produce mineral oil.

After primary production, secondary production is therefore typically used. In secondary production, in addition to the boreholes which serve for the production of the mineral oil, known as the production boreholes, further boreholes are drilled into the mineral oil-bearing formation. These are known as injection boreholes, through which water is injected into the deposit (known as “water flooding”), in order to maintain the pressure or to increase it again. As a result of the injection of the water, the mineral oil is gradually forced through the cavities in the formation, proceeding from the injection borehole, in the direction of the production borehole. However, this works only for as long as the cavities are completely filled with oil and the more viscous oil is pushed onward by the water. As soon as the mobile water breaks through cavities, it flows on the path of least resistance from this time onward, i.e. through the channel formed, and no longer pushes the oil onward. By means of primary and secondary production, therefore, generally only approx. 30 to 35% of the amount of mineral oil present in the deposit can be produced.

After the measures of secondary mineral oil production, measures of tertiary mineral oil production (also known as “Enhanced Oil Recovery (EOR)”) are therefore also used to further enhance the oil yield. This includes processes in which particular chemicals, such as surfactants and/or polymers, are used as assistants for oil production. An overview of tertiary oil production using chemicals can be found, for example, in the article by D. G. Kessel, Journal of Petroleum Science and Engineering, 2 (1989) 81-101.

The techniques of tertiary mineral oil production include what is known as “polymer flooding”. Polymer flooding involves injecting an aqueous solution of a thickening polymer through the injection boreholes into the mineral oil deposit, the viscosity of the aqueous polymer solution being matched to the viscosity of the mineral oil. As a result of the injection of the polymer solution, the mineral oil, as in the case of water flooding, is forced through the cavities mentioned in the formation, proceeding from the injection borehole, in the direction of the production borehole, and the mineral oil is produced through the production borehole. By virtue of the fact that the polymer formulation, however, has about the same viscosity as the mineral oil, the risk is reduced that the polymer formulation breaks through to the production borehole with no effect, and hence the mineral oil is mobilized much more homogeneously than in the case of use of mobile water. It is thus possible to mobilize additional mineral oil in the formation. Details of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”.

For polymer flooding, a multitude of different thickening polymers have been proposed, especially high molecular weight polyacrylamide, copolymers of acrylamide and further comonomers, for example vinylsulfonic acid or acrylic acid. Polyacrylamide may especially be partly hydrolyzed polyacrylamide, in which some of the acrylamide units have been hydrolyzed to acrylic acid. In addition, it is also possible to use naturally occurring polymers, for example xanthan or polyglycosylglucan, as described, for example, by U.S. Pat. No. 6,392,596 B1 or CA 832 277.

Also known is the use of hydrophobically associating copolymers for polymer flooding. These are understood by the person skilled in the art to mean water-soluble polymers which have lateral or terminal hydrophobic groups, for example relatively long alkyl chains. In aqueous medium, such hydrophobic groups can associate with themselves or with other substances having hydrophobic groups. This forms an associative network by which the medium is thickened. Details of the use of hydrophobically associating copolymers for tertiary mineral oil production are described, for example, in the review article by Taylor, K. C. and Nasr-El-Din, H. A. in J. Petr. Sci. Eng. 1998, 19, 265-280.

EP 705 854 A1, DE 100 37 629 A1 and DE 10 2004 032 304 A1 disclose water-soluble, hydrophobically associating copolymers and the use thereof, for example in the construction chemistry sector. The copolymers described comprise acidic monomers, for example acrylic acid, vinylsulfonic acid, acrylamidomethylpropanesulfonic acid, basic monomers such as acrylamide, dimethylacrylamide, or monomers comprising cationic groups, for example monomers having ammonium groups, and also monomers which can bring about the hydrophobic association of the individual polymer chains.

Our prior application WO 2010/133527 A2 discloses hydrophobically associating copolymers which comprise at least hydrophilic, monoethylenically unsaturated monomers, for example acrylamide, and monoethylenically unsaturated, hydrophobically associating monomers. The hydrophobically associating monomers have a block structure and have—in this sequence—an ethylenically unsaturated group, optionally a linking group, a first polyoxyalkylene block which comprises at least 50 mol % of ethyleneoxy groups, and a second polyoxyalkylene group which consists of alkyleneoxy groups having at least 4 carbon atoms. The application discloses the use of such copolymers as thickeners, for example for polymer flooding, for construction chemical applications or for detergent formulations.

Our prior application WO 2011/015520 A1 discloses a process for preparing hydrophobically associating copolymers by polymerizing water-soluble, monoethylenically unsaturated surface-active monomers and monoethylenically unsaturated hydrophilic monomers in the presence of surfactants, and the use of such copolymers for polymer flooding.

For polymer flooding, an aqueous, viscous polymer formulation is injected into a borehole sunk into the mineral oil formation. This borehole is also called “injection borehole” and is generally lined with cemented steel tubes which are perforated in the region of the mineral oil formation and thus allow the discharge of the polymer formulation from the injection borehole into the mineral oil formation.

Naturally, the aqueous polymer formulation on entry into the mineral oil formation must at first flow through the volume element immediately around the injection borehole, and is further distributed from there in the mineral oil formation. Accordingly, the flow rate of the aqueous polymer formulation on entry into the formation is at its greatest and decreases with increasing distance from the injection borehole. This is shown schematically in FIG. 1. Since the mineral oil formation is a porous material and the formulation has to flow through the pores, very high shear forces are acting on the aqueous polymer formulation on entry into the formation.

In this case, the problem occurs with customary thickening polymers based on acrylamide that the polymers lose some of their viscosity-enhancing properties, specifically as a result of mechanical degradation of the polymer owing to high shear forces (see, for example, J. M. Maerker, Shear Degradation of partially hydrolyzes polyacrylamide solutions”, SPE Journal 15(4), 1975, pages 311-322 or R. S. Seright, “The effects of mechanical degradation and viscoelastic behavior on injectivity of polyacrylamide solutions”, SPE Journal 23(3), 1983, pages 475-485).

Various measures have been proposed to solve the problem, for example slower injection of the polymer solution, fracturing of the formation close to the injection borehole, preliminary shear of the polymer solution, or the use of a higher polymer concentration than actually needed to build up the desired viscosity (see, for example, D. Morel, M. Vert, S. Jouenne, E. Nahas, “Polymer injection in deep offshore field: The Dalia Angola case”, SPE Annual Technical Conference and Exhibition, September 2008, Denver Colo., USA, paper number: SPE 116672). However, all proposed solutions have the disadvantage that they impair the economic viability of polymer flooding, whether because the amounts of the polymer used have to be increased or because the reduced injection rate decreases the amount of mineral oil produced. Naturally, the problem of injection in mineral oil formations with a low porosity is higher than in the case of a formation of higher porosity.

R. S. Seright, M. Seheult and T. Talashek “Injectivity characteristics of EOR polymers”; SPE Reservoir Evaluation & Engineering, 12 (5), 2009, pages 783-792 describe studies of the injection of aqueous solutions of xanthan and partly hydrolyzed polyacrylamide into mineral oil formations. They indicate that essentially three polymer properties are crucial for the injectivity of EOR polymers, namely gel fractions in the polymer, polymer rheology in the course of flow in the porous medium, and mechanical polymer degradation. Gel fractions in the EOR polymer can lead to blockage of the formation and thus make it more difficult to inject the EOR polymer. Blockages can also occur primarily on entry of the aqueous polymer formulation into the mineral oil formation. In order to facilitate the injection of the EOR polymers, polymer solutions with structurally viscous flow behavior are preferred. “Structurally viscous flow behavior” means, in a manner known in principle, that the viscosity of a solution decreases with increasing shear.

It was an object of the invention to provide an improved process for polymer flooding, especially for fine-pore mineral oil formations, in which the polymer can be injected particularly efficiently into the formation.

In a first aspect of the invention, a process for mineral oil production has been found, in which an aqueous formulation comprising at least one water-soluble, hydrophobically associating copolymer is injected through at least one injection borehole into a mineral oil deposit having an average porosity of 10 millidarcies to 4 darcies and a formation temperature of 30° C. to 150° C., and crude oil is withdrawn from the deposit through at least one production borehole, and wherein
the water-soluble, hydrophobically associating copolymer comprises
   (a) 0.1 to 15% by weight of at least one monoethylenically unsaturated, hydrophobically associating monomer (a), and
   (b) 85 to 99.9% by weight of at least two monoethylenically unsaturated, hydrophilic monomers (b) different than (a), where the monomers (b) comprise at least
      (b1) at least one uncharged, monoethylenically unsaturated, hydrophilic monomer (b1), selected from the group of (meth)acrylamide, N-methyl(meth)acrylamide, N,N′-dimethyl(meth)acrylamide or N-methylol(meth)acrylamide, and
      (b2) at least one anionic, monoethylenically unsaturated, hydrophilic monomer (b2) which at least one acidic group selected from the group of —COOH, —SO₃H and —PO₃H₂ and salts thereof,
where the proportions are each based on the total amount of all monomers in the copolymer,
the copolymer has a weight-average molecular weight M_{W} of 1*10⁶ g/mol to 30*10⁶ g/mol,
the amount of the copolymer in the formulation is 0.02 to 2% by weight,
the viscosity of the formulation is at least 5 mPas (measured at 25° C.), and
the aqueous polymer formulation is injected into the formation with a shear rate of at least 30 000 s⁻¹.

In a second aspect of the invention, water-soluble, hydrophobically associating copolymers having a weight-average molecular weight M_{W} of 1*10⁶ g/mol to 30*10⁶ g/mol have been found, comprising at least
(a) 0.1 to 15% by weight of at least one monoethylenically unsaturated, hydrophobically associating monomer (a), and
(b) 85 to 99.9% by weight of at least one monoethylenically unsaturated, hydrophilic monomer (b) different than (a), where the monomers (b) comprise at least
   (b1) at least one uncharged, monoethylenically unsaturated, hydrophilic monomer (b1), selected from the group of (meth)acrylamide, N-methyl(meth)acrylamide, N,N′-dimethyl(meth)acrylamide or N-methylol(meth)acrylamide, and
   (b2) at least one anionic, monoethylenically unsaturated, hydrophilic monomer (b2) which at least one acidic group selected from the group of —COOH, —SO₃H and —PO₃H₂ and salts thereof,
      where the proportions are each based on the total amount of all monomers in the copolymer, wherein the shear degradation of the copolymer, measured by means of a capillary shear test to API RP 63, is not more than 10%.

### INDEX OF FIGURES

FIG. 1 Schematic diagram of the entrance of an injection liquid into the mineral oil formation.

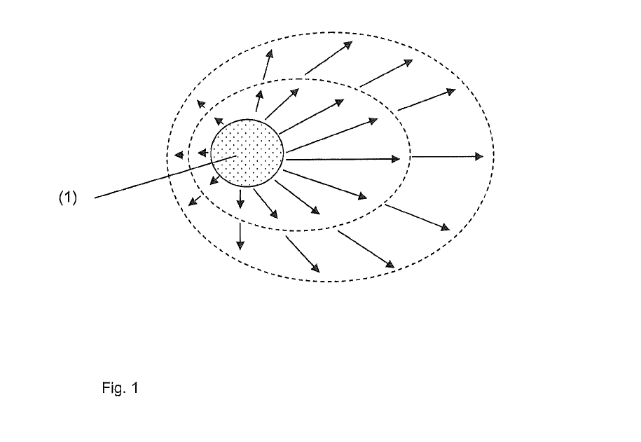

FIG. 2 Schematic diagram of the apparatus for determining the shear stability according to API RP 63.

With regard to the invention, the following should be stated specifically:

### Hydrophobically Associating Copolymers Used

For the process according to the invention for mineral oil production, an aqueous formulation of at least one water-soluble, hydrophobically associating copolymer is used and is injected through an injection borehole into a mineral oil deposit.

The term “hydrophobically associating copolymer” is known in principle to those skilled in the art.

This comprises a water-soluble copolymer which, as well as hydrophilic molecular components which ensure sufficient water solubility, has lateral or terminal hydrophobic groups. In aqueous solution, the hydrophobic groups of the polymer can associate with themselves or with other substances having hydrophobic groups due to intermolecular forces. This gives rise to a polymeric network joined by intermolecular forces, which thickens the aqueous medium.

In the ideal case, the copolymers used in accordance with the invention should be miscible with water in any ratio. According to the invention, however, it is sufficient when the copolymers are water-soluble at least at the desired use concentration and at the desired pH. In general, the solubility of the copolymer in water at room temperature under the use conditions should be at least 25 g/l.

According to the invention, the water-soluble, hydrophobically associating copolymer comprises 0.1 to 15% by weight of at least one monoethylenically unsaturated, hydrophobically associating monomer (a) and 85 to 99.9% by weight of at least two monoethylenically unsaturated, hydrophilic monomers (b) different than (a). In addition, it is optionally possible for further, ethylenically unsaturated, preferably monoethylenically unsaturated, monomers (c) different than the monomers (a) and (b) to be present in an amount of up to 14.9% by weight. The amounts mentioned are based in each case on the sum of all monomers in the copolymer. Preference is given to using exclusively monoethylenically unsaturated monomers.

### Monomers (a)

The water-soluble, hydrophobically associating copolymer used comprises at least one monoethylenically unsaturated monomer (a) which imparts hydrophobically associating properties to the copolymer and shall therefore be referred to hereinafter as “hydrophobically associating monomer”.

The hydrophobically associating monomers (a) comprise, as well as the ethylenically unsaturated group, a hydrophobic group which, after the polymerization, is responsible for the hydrophobic association of the copolymer formed. They preferably further comprise hydrophilic molecular components which impart a certain water solubility to the monomer. In principle, it is possible to use any hydrophobically associating, monoethylenically unsaturated monomers (a), provided that the copolymer can be injected into the formation at a shear rate of at least 30 000 s⁻¹. The person skilled in the art is aware of monomers (a), and makes a suitable selection.

Suitable monomers (a) have especially the general formula H₂C═C(R¹)—Y—Z where R¹ is H or methyl, Z is a terminal hydrophobic group and Y is a linking hydrophilic group. In a preferred embodiment of the invention, the hydrophobic Z group comprises aliphatic and/or aromatic, straight-chain or branched C₈-C₃₂-hydrocarbyl radicals, preferably C₁₂-C₃₀-hydrocarbyl radicals. In a further preferred embodiment, the Z group is a group formed from alkylene oxide units having at least 3 carbon atoms, preferably at least 4 and more preferably at least 5 carbon atoms. The Y group is preferably a group comprising alkylene oxide units, for example a group comprising 5 to 150 alkylene oxide units, which is joined in a suitable manner to the H₂C═C(R¹)— group, for example by means of a single bond or of a suitable linking group, using at least 50 mol %, preferably at least 90 mol %, of ethylene oxide units.

### Preferred Monomers (a)

At least one of the monoethylenically unsaturated water-soluble monomers (a) is preferably at least one selected from the group of

H₂C═C(R¹)—R²—O—(—CH₂—CH(R³)—O—)ₖ—(—CH₂—CH(R⁴)—O—)ₗ—R⁵ (I),

H₂C═C(R¹)—O—(—CH₂—CH(R³)—O—)ₖ—R⁶ (II),

H₂C═C(R¹)—(C═O)—O—(—CH₂—CH(R³)—O—)ₖ—R⁶ (III).

### Monomers (a) of the Formula (I)

In the monomers (a) of the formula (I), an ethylenic group H₂C═C(R¹)— is bonded via a divalent linking group —R²—O— to a polyoxyalkylene radical with block structure —(—CH₂—CH(R³)—O—)ₖ—(—CH₂—CH(R⁴)—O—)ₗ—R⁵, where the two blocks —(—CH₂—CH(R³)—O—)ₖ and —(—CH₂—CH(R⁴)—O—)ₗ are arranged in the sequence shown in formula (I). The polyoxyalkylene radical has either a terminal OH group (when R⁵=H) or a terminal ether group —OR⁵ (when R⁵ is a hydrocarbyl radical).

In the abovementioned formula, R¹ is H or a methyl group.

R² is a single bond or a divalent linking group selected from the group of —(CₙH₂ₙ)—[R^{2a} group], —O—(C_{n′}H_{2n′})—[R^{2b} group]- and —C(O)—O—(C_{n″}H_{2n″})—[R^{2c} group]. In the formulae mentioned, n, n′ and n″ are each a natural number from 1 to 6. In other words, the linking group comprises straight-chain or branched aliphatic hydrocarbyl groups having 1 to 6 hydrocarbon atoms, which are joined to the ethylenic group H₂C═C(R¹)— directly, via an ether group —O— or via an ester group —C(O)—O—. The —(CₙHₙ)—, —(C_{n′}H_{2n′})— and —(C_{n″}H_{2n″})— groups are preferably linear aliphatic hydrocarbyl groups.

The R^{2a} group is preferably a group selected from —CH₂—, —CH₂—CH₂— and —CH₂—CH₂—CH₂—, more preferably a methylene group —CH₂—.

The R^{2b} group is preferably a group selected from —O—CH₂—CH₂—, —O—CH₂—CH₂—CH₂— and —O—CH₂—CH₂—CH₂—CH₂—, more preferably —O—CH₂—CH₂—CH₂—CH₂—.

The R^{2c} group is preferably a group selected from —C(O)—O—CH₂—CH₂—, —C(O)O—CH(CH₃)—CH₂—, —C(O)O—CH₂—CH(CH₃)—, —C(O)O—CH₂—CH₂—CH₂—CH₂— and —C(O)O—CH₂—CH₂—CH₂—CH₂—CH₂—CH₂—, more preferably —C(O)—O—CH₂—CH₂— and —C(O)O—CH₂—CH₂—CH₂—CH₂—, and most preferably —C(O)—O—CH₂—CH₂—.

The R² group is more preferably an R^{2a} or R^{2b} group, more preferably an R^{2b} group, i.e. monomers based on vinyl ethers.

In addition, R² is more preferably a group selected from —CH₂— and —O—CH₂—CH₂—CH₂—CH₂—, most preferably —O—CH₂—CH₂—CH₂—CH₂—.

The monomers (I) also have a polyoxyalkylene radical which consists of the units —(—CH₂—CH(R³)—O—)ₖ and —(—CH₂—CH(R⁴)—O—)ₗ where the units are arranged in block structure in the sequence shown in formula (I). The transition between the two blocks may be abrupt or else continuous.

In the —(—CH₂—CH(R³)—O—)ₖ block, the R³ radicals are each independently H, methyl or ethyl, preferably H or methyl, with the proviso that at least 50 mol % of the R³ radicals are H. Preferably at least 75 mol % of the R³ radicals are H, more preferably at least 90 mol %, and they are most preferably exclusively H. The block mentioned is thus a polyoxyethylene block which may optionally also have certain proportions of propylene oxide and/or butylene oxide units, preferably a pure polyoxyethylene block.

The number of alkylene oxide units k is a number from 10 to 150, preferably 12 to 100, more preferably 15 to 80, even more preferably 20 to 30 and, for example, approx. 22 to 25. It is clear to the person skilled in the art in the field of the polyalkylene oxides that the numbers mentioned are averages of distributions.

In the second —(—CH₂—CH(R⁴)—O—)ₗ— block, the R⁴ radicals are each independently hydrocarbyl radicals of at least 2 carbon atoms, preferably at least 3, more preferably 3 to 10, most preferably 3 to 8 carbon atoms and, for example, 3 to 4 carbon atoms. This may be an aliphatic and/or aromatic, linear or branched carbon radical. It is preferably an aliphatic radical.

Examples of suitable R⁴ radicals comprise ethyl, n-propyl, n-butyl, n-pentyl, n-hexyl, n-heptyl, n-octyl, n-nonyl or n-decyl, and phenyl. Examples of preferred radicals comprise n-propyl, n-butyl, n-pentyl, particular preference being given to an n-propyl radical.

The R⁴ radicals may also be ether groups of the general formula —CH₂—O—R^{4′} where R^{4′} is an aliphatic and/or aromatic, linear or branched hydrocarbyl radical having at least 2 carbon atoms, preferably at least 3 and more preferably 3 to 10 carbon atoms. Examples of R^{3′} radicals comprise n-propyl, n-butyl, n-pentyl, n-hexyl, 2-ethylhexyl, n-heptyl, n-octyl, n-nonyl n-decyl or phenyl.

The —(—CH₂—CH(R⁴)—O—)ₗ— block is thus a block which consists of alkylene oxide units having at least 4 carbon atoms, preferably at least 5 carbon atoms, especially 5 to 10 carbon atoms, and/or glycidyl ethers having an ether group of at least 2, preferably at least 3, carbon atoms. Preferred R³ radicals are the hydrocarbyl radicals mentioned; the units of the second terminal block are more preferably alkylene oxide units comprising at least 5 carbon atoms, such as pentene oxide units or units of higher alkylene oxides.

The number of alkylene oxide units I is a number from 5 to 25, preferably 6 to 20, more preferably 8 to 18, even more preferably 10 to 15 and, for example, approx. 12.

The R⁵ radical is H or a preferably aliphatic hydrocarbyl radical having 1 to 30 carbon atoms, preferably 1 to 10 and more preferably 1 to 5 carbon atoms. R⁵ is preferably H, methyl or ethyl, more preferably H or methyl and most preferably H.

In the monomers of the formula (I), a terminal monoethylenic group is joined to a polyoxyalkylene group with block structure, specifically firstly to a hydrophilic block having polyethylene oxide units, which is in turn joined to a second terminal hydrophobic block formed at least from butene oxide units, preferably at least pentene oxide units, or units of higher alkylene oxides, for example dodecene oxide. The second block has a terminal —OR⁵— group, especially an OH-group. The terminal —(—CH₂—CH(R⁴)—O—)ₗ block with the R⁴ radicals is responsible for the hydrophobic association of the copolymers prepared using the monomers (a). Etherification of the OH end group is an option which may be selected by the person skilled in the art according to the desired properties of the copolymer. A terminal hydrocarbyl group is, however, not required for the hydrophobic association, and the hydrophobic association also works with a terminal OH group.

It is clear to the person skilled in the art in the field of polyalkylene oxide block copolymers that the transition between the two blocks, according to the method of preparation, may be abrupt or else continuous. In the case of a continuous transition, there is a transition zone between the two blocks, which comprises monomers of both blocks. When the block boundary is fixed at the middle of the transition zone, the first block —(—CH₂—CH(R³)—O—)ₖ may accordingly also have small amounts of —CH₂—CH(R⁴)—O— units and the second block —(—CH₂—CH(R⁴)—O—)ₗ— small amounts of —CH₂—CH(R³)—O— units, though these units are not distributed randomly over the block but arranged in the transition zone mentioned.

### Preparation of the Monomers (a) of the Formula (I)

The hydrophobically associating monomers (a) of the formula (I) can be prepared by methods known in principle to those skilled in the art.

To prepare the monomers (a), a preferred preparation process proceeds from suitable monoethylenically unsaturated alcohols (IV) which are subsequently alkoxylated in a two-stage process such that the block structure mentioned is obtained. This gives monomers (a) of the formula (I) where R⁵═H. These can optionally be etherified in a further process step. The type of ethylenically unsaturated alcohols (IV) to be used is guided here especially by the R² group.

When R² is a single bond, the starting materials are alcohols (IV) of the general formula H₂C═C(R¹)—O—(—CH₂—CH(R⁷)—O—)_{d}—H (IVa) where R¹ is as defined above, R⁷ is H and/or CH₃, preferably H, and d is from 1 to 5, preferably 1 or 2. Examples of such alcohols comprise diethylene glycol vinyl ether H₂C═CH—O—CH₂—CH₂—O—CH₂—CH₂—OH or dipropylene glycol vinyl ether H₂C═CH—O—CH₂—CH(CH₃)—O—CH₂—CH(CH₃)—OH, preferably diethylene glycol vinyl ether.

To prepare monomers (a) in which R² is not a single bond, it is possible to use alcohols of the general formula H₂C═C(R¹)—R²—OH (IVb) or alcohols which already have alkoxy groups and are of the formula H₂C═C(R¹)—R²—O—(—CH₂—CH(R⁷)—O—)_{d}—H (IVc), where R⁷ and d are each as defined above, and R² in each case is selected from the group of R^{2a}, R^{2b} and R^{2c}.

The preparation of the monomers with a linking R^{2a} group preferably proceeds from alcohols of the formula H₂C═C(R¹)—(CₙH₂ₙ)—OH, especially H₂C═CH—(CₙH₂ₙ)—OH, or alcohols of the formula H₂C═C(R¹)—O—(—CH₂—CH(R⁷)—O—)_{d}—H. Examples of preferred alcohols comprise allyl alcohol H₂C═CH—CH₂—OH or isoprenol H₂C═C(CH₃)—CH₂—CH₂—OH.

The preparation of the monomers with a linking R^{2b} group proceeds from vinyl ethers of the formula H₂C═C(R¹)—O—(C_{n′}H_{2n′})—O—OH, preferably H₂C═CH—O—(C_{n′}H_{2n′})—OH. It is more preferably possible to use ω-hydroxybutyl vinyl ether H₂C═CH—O—CH₂—CH₂—CH₂—CH₂—OH.

The preparation of the monomers with a linking R^{2c} group proceeds from hydroxyalkyl (meth)acrylates of the general formula H₂C═C(R¹)—C(O)—O—(C_{n″}H_{2n″})—OH, preferably H₂C═C(R¹)—C(O)—O—(C_{n″}H_{2n″})—OH. Examples of preferred hydroxyalkyl (meth)acrylates comprise hydroxyethyl (meth)acrylate H₂C═C(R¹)—C(O)—O—CH₂—CH₂—OH and hydroxybutyl (meth)acrylate H₂C═C(R¹)—C(O)—O—CH₂—CH₂—CH₂—CH₂—OH.

The starting compounds mentioned are alkoxylated, specifically in a two-stage process, first with ethylene oxide, optionally in a mixture with propylene oxide and/or butylene oxide, and in a second step with alkylene oxides of the general formula (Xa) or (Xb)

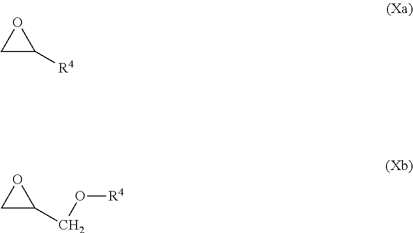

where R⁴ in (Xa) and R^{4′} in (Xb) are each as defined at the outset.

The performance of an alkoxylation including the preparation of the block copolymers from different alkylene oxides is known in principle to those skilled in the art. It is likewise known to those skilled in the art that the reaction conditions, especially the selection of the catalyst, can influence the molecular weight distribution of the alkoxylates and the orientation of the alkylene oxide units in a polyether chain.

The alkoxylates can be prepared, for example, by base-catalyzed alkoxylation. For this purpose, the alcohol used as the starting material can be admixed in a pressure reactor with alkali metal hydroxides, preferably potassium hydroxide, or with alkali metal alkoxides, for example sodium methoxide. By means of reduced pressure (e.g. <100 mbar) and/or increasing the temperature (30 to 150° C.), water still present in the mixture can be removed. Thereafter, the alcohol is present as the corresponding alkoxide. This is followed by inertization with inert gas (e.g. nitrogen) and, in a first step, stepwise addition of ethylene oxide, optionally in a mixture with propylene oxide and/or butylene oxide, at temperatures of 60 to 180° C., preferably 130 to 150° C. The addition is typically effected within 2 to 5 h, though the invention should not be restricted thereto. After the addition has ended, the reaction mixture is appropriately allowed to continue to react, for example for ½ h to 1 h. In a second step, alkylene oxides of the general formula (Xb) are subsequently metered in stepwise. The reaction temperature in the second stage can be maintained or else altered. A reaction temperature lower by approx. 10 to 25° C. than in the first stage has been found to be useful.

The alkoxylation can also be undertaken by means of techniques which lead to narrower molecular weight distributions than the base-catalyzed synthesis. For this purpose, the catalysts used may, for example, be double hydroxide clays as described in DE 43 25 237 A1. The alkoxylation can more preferably be effected using double metal cyanide catalysts (DMC catalysts). Suitable DMC catalysts are disclosed, for example, in DE 102 43 361A1, especially paragraphs [0029] to [0041] and the literature cited therein. For example, it is possible to use catalysts of the Zn—Co type. To perform the reaction, the alcohol used as the starting material can be admixed with the catalyst, and the mixture can be dewatered as described above and reacted with the alkylene oxides as described. Typically, not more than 250 ppm of catalyst based on the mixture are used, and the catalyst can remain in the product due to this small amount.

The alkoxylation can additionally also be undertaken under acid catalysis. The acids may be Brønsted or Lewis acids. To perform the reaction, the alcohol used as the starting material can be admixed with the catalyst, and the mixture can be dewatered as described above and reacted with the alkylene oxides as described. At the end of the reaction, the acidic catalyst can be neutralized by addition of a base, for example KOH or NaOH, and filtered off if required.

It is clear to the person skilled in the art in the field of the polyalkylene oxides that the orientation of the hydrocarbyl radicals R⁴ and optionally R³ may depend on the conditions of the alkoxylation, for example on the catalyst selected for the alkoxylation. The alkylene oxide groups can thus be incorporated into the monomer either in the —(—CH₂—CH(R⁴)—O—) orientation or else in the inverse —(—CH(R⁴)—CH₂—O—)— orientation. The description in formula (I) should therefore not be considered to be restricted to a particular orientation of the R³ or R⁴ groups.

When the terminal OH group of the monomers (a) of the formula (I) (i.e. R⁵=H) is to be etherified, this can be accomplished with customary alkylating agents known in principle to those skilled in the art, for example alkyl sulfates. For etherification, it is especially possible to use dimethyl sulfate or diethyl sulfates.

The preferred preparation process described for the monomers (I) has the advantage that the formation of potentially crosslinking by-products with two ethylenically unsaturated groups is substantially avoided. Accordingly, it is possible to obtain copolymers with a particularly low gel content.

### Monomers (a) of the Formulae (II) and (III)

In the monomers of the formulae (II) and (III), R¹, R³ and k are each defined as already outlined.

R⁶ is an aliphatic and/or aromatic, straight-chain or branched hydrocarbyl radical having 8 to 40 carbon atoms, preferably 12 to 32 carbon atoms. For example, it may comprise n-alkyl groups such as n-octyl, n-decyl or n-dodecyl groups, phenyl groups, and especially substituted phenyl groups. Substituents on the phenyl groups may be alkyl groups, for example C₁-C₈-alkyl groups, preferably styryl groups. Particular preference is given to a tristyrylphenyl group.

The hydrophobically associating monomers of the formulae (II) and (III) and the preparation thereof are known in principle to those skilled in the art, for example from EP 705 854 A1.

### Amounts of Monomers (a)

The amount of the monoethylenically unsaturated, hydrophobically associating monomers (a) is 0.1 to 15% by weight, based on the total amount of all monomers in the copolymer, especially 0.1 to 10% by weight, preferably 0.2 to 5% by weight and more preferably 0.5 to 2% by weight.

In general, at least 50% by weight, preferably at least 80% by weight, of the monomers (a) are monomers (a) of the general formula (I), (II) and/or (III), and particular preference is given to using only monomers (a) of the general formula (I), (II) and/or (III). Particular preference is given to using only monomers (a) of the general formula (I) to prepare the inventive copolymers, most preferably monomers (a) of the general formula (I) in which R² is an R^{2b} radical.

### Monomers (b)

Over and above the monomers (a), the hydrophobically associating copolymer used in accordance with the invention comprises at least two monoethylenically unsaturated, hydrophilic monomers (b) different than (a).

More preferably, the monoethylenically unsaturated hydrophilic monomers (b) used are miscible with water in any ratio, but it is sufficient for execution of the invention that the inventive, hydrophobically associating copolymer possesses the water solubility mentioned at the outset. In general, the solubility of the monomers (b) in water at room temperature should be at least 50 g/l, preferably at least 150 g/l and more preferably at least 250 g/l.

According to the invention, the copolymer comprises at least one uncharged, monoethylenically unsaturated, hydrophilic monomer (b1) selected from the group of (meth)acrylamide, N-methyl(meth)acrylamide, N,N′-dimethyl(meth)acrylamide or N-methylol-(meth)acrylamide. Preference is given to (meth)acrylamide, especially acrylamide. When mixtures of different monomers (b1) are used, at least 50 mol % of the monomers (b1) should be (meth)acrylamide, especially acrylamide.

According to the invention, the copolymer used further comprises at least one hydrophilic, monoethylenically unsaturated anionic monomer (b2) which comprises at least one acidic group selected from the group of —COOH, —SO₃H and —PO₃H₂ and salts thereof. Preference is given to monomers comprising COOH groups and/or —SO₃H groups, particular preference to monomers comprising —SO₃H groups. The monomers may of course also be the salts of the acidic monomers. Suitable counterions comprise especially alkali metal ions such as Li⁺, Na⁺ or K⁺, and ammonium ions such as NH₄⁺ or ammonium ions with organic radicals.

Examples of monomers comprising COOH groups comprise acrylic acid, methacrylic acid, crotonic acid, itaconic acid, maleic acid or fumaric acid. Preference is given to acrylic acid.

Examples of monomers comprising sulfo groups comprise vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preference is given to vinylsulfonic acid, allylsulfonic acid or 2-acrylamido-2-methylpropanesulfonic acid, and particular preference to 2-acrylamido-2-methylpropanesulfonic acid.

Examples of monomers comprising phospho groups comprise vinylphosphonic acid, allylphosphonic acid, N-(meth)acrylamidoalkylphosphonic acids or (meth)acryloyloxyalkyl-phosphonic acids, preference being given to vinylphosphonic acid.

For the sake of completeness, it should be mentioned that the monomers (b1) can be hydrolyzed at least partly to (meth)acrylic acid under some circumstances in the course of preparation and use. The copolymers used in accordance with the invention may accordingly comprise (meth)acrylic acid units, even if no (meth)acrylic acid units at all have been used for the synthesis. The tendency to hydrolysis of the monomers (b1) decreases with increasing content of sulfo groups. Accordingly, the presence of sulfo groups in the copolymer used in accordance with the invention is advisable.

The copolymers used in accordance with the invention may additionally optionally comprise at least one monoethylenically unsaturated, cationic monomer (b3) having ammonium ions.

Suitable cationic monomers (b3) comprise especially monomers having ammonium groups, especially ammonium derivatives of N-(ω-aminoalkyl)(meth)acrylamides or ω-aminoalkyl-(meth)acrylic esters.

More particularly, monomers (b3) having ammonium groups may be compounds of the general formulae H₂C═C(R⁸)—CO—NR⁹—R¹⁰—NR¹¹₃⁺X⁻ (Va) and/or H₂C═C(R⁸)—COO—R¹⁰—NR¹¹₃⁺X⁻ (Vb). In these formulae, R⁸ is H or methyl, R⁹ is H or a C₁-C₄-alkyl group, preferably H or methyl, and R¹⁰ is a preferably linear C₁-C₄-alkylene group, for example a 1,2-ethylene group —CH₂—CH₂— or a 1,3-proplyene group —CH₂—CH₂—CH₂—.

The R¹¹ radicals are each independently C₁-C₄-alkyl radicals, preferably methyl, or a group of the general formula —R¹²—SO₃H where R¹² is a preferably linear C₁-C₄alkylene group or a phenyl group, with the proviso that generally not more than one of the R¹¹ substituents is a substituent having sulfo groups. More preferably, the three R¹¹ substituents are methyl groups, i.e. the monomer has a —N(CH₃)₃⁺ group. X⁻ in the above formula is a monovalent anion, for example Cl⁻. X⁻ may of course also be a corresponding fraction of a polyvalent anion, though this is not preferred. Examples of preferred monomers (b3) of the general formula (Va) or (Vb) comprise salts of 3-trimethylammoniopropyl(meth)acrylamides or 2-trimethylammonioethyl (meth)acrylates, for example the corresponding chlorides such as 3-trimethylammoniopropylacrylamide chloride (DIMAPAQUAT) and 2-trimethylammoniomethyl methacrylate chloride (MADAME-QUAT).

The copolymers used in accordance with the invention may additionally also comprise further monoethylenically unsaturated hydrophilic monomers (b4) different than the hydrophilic monomers (b1), (b2) and (b3). Examples of such monomers comprise monomers comprising hydroxyl groups and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether, or compounds of the formula H₂C═C(R¹)—COO—(—CH₂—CH(R¹³)—O—)_{b}—R¹⁴ (VIa) or H₂C═C(R¹)—O—(—CH₂—CH(R¹³)—O—)_{b}—R¹⁴ (VIb), where R¹ is as defined above and b is a number from 2 to 200, preferably 2 to 100. The R¹³ radicals are each independently H, methyl or ethyl, preferably H or methyl, with the proviso that at least 50 mol % of the R¹³ radicals are H. Preferably at least 75 mol % of the R¹³ radicals are H, more preferably at least 90 mol %, and they are most preferably exclusively H. The R¹⁴ radical is H, methyl or ethyl, preferably H or methyl. Further examples of monomers (b4) comprise N-vinyl derivatives, for example N-vinylformamide, N-vinylacetamide, N-vinylpyrrolidone or N-vinylcaprolactam, and vinyl esters, for example vinyl formate or vinyl acetate. N-Vinyl derivatives can be hydrolyzed after polymerization to give vinylamine units, and vinyl esters to give vinyl alcohol units.

The amount of all hydrophilic monomers (b) in the inventive copolymer is, in accordance with the invention, 85 to 99.9% by weight, based on the total amount of all monomers in the copolymer, preferably 90 to 99.8% by weight.

The amount of the uncharged, hydrophilic monomers (b1) here is generally 30 to 95% by weight, preferably 30 to 85% by weight and more preferably 30 to 70% by weight, based on the total amount of all monomers used.

When the copolymer comprises only uncharged monomers (b1) and anionic monomers (b2), it has been found to be useful to use the uncharged monomers (b1) in an amount of 30 to 95% by weight and the anionic monomers (b2) in an amount of 4.9 to 69.9% by weight, each amount being based on the total amount of all monomers used. In this embodiment, the monomers (b1) are preferably used in an amount of 30 to 80% by weight and the anionic monomers (b2) in an amount of 19.9 to 69.9% by weight, and the monomers (b1) are more preferably used in an amount of 40 to 70% by weight and the anionic monomers (b2) in an amount of 29.9 to 59.9% by weight

When the copolymer comprises uncharged monomers (b1), anionic monomers (b2) and cationic monomers (b3), it has been found to be useful to use the uncharged monomers (b1) in an amount of 30 to 95% by weight, and the anionic (b2) and cationic (b3) monomers together in an amount of 4.9 to 69.9% by weight, with the proviso that the molar (b2)/(b3) ratio is 0.7 to 1.3. The molar (b2)/(b3) ratio is preferably 0.8 to 1.2 and, for example, 0.9 to 1.1. This measure makes it possible to obtain copolymers which are particularly insensitive to salt burden. In this embodiment, the monomers (b1) are used in an amount of 30 to 80% by weight, and the anionic and cationic monomers (b2)+(b3) together in an amount of 19.9 to 69.9% by weight, and the monomers (b1) are more preferably used in an amount of 40 to 70% by weight and the anionic and cationic monomers (b2)+(b3) together in an amount of 29.9 to 59.9% by weight, where the molar ratio already mentioned should be observed in each case.

### Monomers (c)

In addition to the hydrophilic monomers (a) and (b), the inventive copolymers may optionally comprise ethylenically unsaturated monomers different than the monomers (a) and (b), preferably monoethylenically unsaturated monomers (c). Of course, it is also possible to use mixtures of a plurality of different monomers (c).

Such monomers can be used for fine control of the properties of the copolymer used in accordance with the invention. If present at all, the amount of such optionally present monomers (c) may be up to 14.9% by weight, preferably up to 9.9% by weight, more preferably up to 4.9% by weight, based in each case on the total amount of all monomers. Most preferably, no monomers (c) are present.

The monomers (c) may, for example, be monoethylenically unsaturated monomers which have more hydrophobic character than the hydrophilic monomers (b) and which are accordingly water-soluble only to a minor degree. In general, the solubility of the monomers (c) in water at room temperature is less than 50 g/l, especially less than 30 g/l. Examples of such monomers comprise N-alkyl- and N,N′-dialkyl(meth)acrylamides, where the number of carbon atoms in the alkyl radicals together is at least 3, preferably at least 4. Examples of such monomers comprise N-butyl(meth)acrylamide, N-cyclohexyl(meth)acrylamide or N-benzyl(meth)acrylamide.

### Preparation of the Hydrophobically Associating Copolymers

The copolymers used in accordance with the invention can be prepared by methods known in principle to those skilled in the art, by free-radical polymerization of the monomers (a), (b) and optionally (c), for example by solution or gel polymerization in the aqueous phase.

For polymerization, the monomers (a), (b), optionally (c), initiators and optionally further assistants for polymerization are used in an aqueous medium.

In a preferred embodiment, the preparation is undertaken by means of gel polymerization in the aqueous phase. For gel polymerization, a mixture of the monomers (a), (b) and optionally (c), initiators and optionally further assistants with water or an aqueous solvent mixture is first provided. Suitable aqueous solvent mixtures comprise water and water-miscible organic solvents, where the proportion of water is generally at least 50% by weight, preferably at least 80% by weight and more preferably at least 90% by weight. Organic solvents in this context include especially water-miscible alcohols such as methanol, ethanol or propanol. Acidic monomers can be fully or partly neutralized before the polymerization. The concentration of all components except the solvents in the course of the polymerization is typically approx. 20 to 60% by weight, preferably approx. 30 to 50% by weight. The polymerization should especially be performed at a pH in the range from 5.0 to 7.5 and preferably at a pH of 6.0.

### Polymerization in the Presence of a Nonpolymerizable, Interface-Active Compound

In a preferred embodiment of the invention, the copolymers used are prepared in the presence of at least one nonpolymerizable, surface-active compound (T).

The nonpolymerizable, surface-active compound (T) is preferably at least one nonionic surfactant, but anionic and cationic surfactants are also suitable to the extent that they do not take part in the polymerization reaction. They may especially be surfactants, preferably nonionic surfactants, of the general formula R¹³—Y′ where R¹³ is a hydrocarbyl radical having 8 to 32, preferably 10 to 20 and more preferably 12 to 18 carbon atoms, and Y′ is a hydrophilic group, preferably a nonionic hydrophilic group, especially a polyalkoxy group.

The nonionic surfactant is preferably an ethoxylated long-chain aliphatic alcohol which may optionally comprise aromatic components.

Examples include: C₁₂C₁₄-fatty alcohol ethoxylates, C₁₆C₁₈-fatty alcohol ethoxylates, C₁₃-oxo alcohol ethoxylates, C₁₀-oxo alcohol ethoxylates, C₁₃C₁₅-oxo alcohol ethoxylates, C₁₀-Guerbet alcohol ethoxylates and alkylphenol ethoxylates. Useful compounds have especially been found to be those having 5 to 20 ethyleneoxy units, preferably 8 to 18 ethyleneoxy units. It is optionally also possible for small amounts of higher alkyleneoxy units to be present, especially propyleneoxy and/or butyleneoxy units, though the amount in the form of ethyleneoxy units should generally be at least 80 mol % based on all alkyleneoxy units.

Especially suitable are surfactants selected from the group of the ethoxylated alkylphenols, the ethoxylated, saturated iso-C13-alcohols and/or the ethoxylated C10-Guerbet alcohols, where in each case 5 to 20 ethyleneoxy units, preferably 8 to 18 ethyleneoxy units, are present in alkoxy radicals.

Surprisingly, the addition of nonpolymerizable, interface-active compounds (T) during the polymerization leads to a distinct improvement in performance properties of the copolymer in polymer flooding. More particularly, the thickening action is increased and the gel content of the copolymer is also reduced.

This effect can probably be explained as follows, without any intention that the invention thus be tied to this explanation: In the case of polymerization without presence of a surfactant, the hydrophobically associating comonomers (a) form micelles in the aqueous reaction medium. In the polymerization, this leads to blockwise incorporation of the hydrophobically associating regions into the polymer. If, in accordance with the invention, an additional surface-active compound is present in the preparation of the copolymers, mixed micelles form. These mixed micelles comprise polymerizable and nonpolymerizable components. As a result, the hydrophobically associating monomers are then incorporated in relatively short blocks. At the same time, the number of these relatively short blocks is greater per polymer chain. Thus, the structure of the copolymers prepared in the presence of a surfactant differs from those without the presence of a surfactant.

The nonpolymerizable, interface-active compounds (T) can generally be used in an amount of 0.1 to 5% by weight, based on the amount of all monomers used.

The weight ratio of the nonpolymerizable, interface-active compounds (T) used to the monomers (a) is generally 4:1 to 1:4, preferably 2:1 to 1:2, more preferably 1.5:1 to 1:1.5 and, for example, approx. 1:1.

### Performance of the Polymerization

For the polymerization, the components required are first mixed with one another. The sequence with which the components are mixed for polymerization is unimportant; what is important is merely that, in the preferred polymerization method, the nonpolymerizable, interface-active compound (T) is added to the aqueous polymerization medium before the initiation of the polymerization.

The mixture is subsequently polymerized thermally and/or photochemically, preferably at −5° C. to 80° C. If polymerization is effected thermally, preference is given to using polymerization initiators which can initiate the polymerization even at comparatively low temperature, for example redox initiators. The thermal polymerization can be undertaken even at room temperature or by heating the mixture, preferably to temperatures of not more than 50° C. The photochemical polymerization is typically undertaken at temperatures of −5 to 10° C. It is also possible to combine photochemical and thermal polymerization with one another, by adding both initiators for the thermal and photochemical polymerization to the mixture. In this case, the polymerization is first initiated photochemically at low temperatures, preferably −5 to +10° C. The heat of reaction released heats the mixture, which additionally initiates the thermal polymerization. By means of this combination, it is possible to achieve a conversion of more than 99%.

In a further preferred embodiment of the polymerization, it is also possible to perform the reaction with a mixture of a redox initiator system and a thermal initiator which does not decompose until relatively high temperatures. This may, for example, be a water-soluble azo initiator which decomposes within the temperature range from 40° C. to 70° C. The polymerization here is at first initiated at low temperatures of, for example, 0 to 10° C. by the redox initiator system. The heat of reaction released heats the mixture, and this additionally initiates the polymerization by virtue of the initiator which does not decompose until relatively high temperatures.

The gel polymerization is generally effected without stirring. It can be effected batchwise by irradiating and/or heating the mixture in a suitable vessel at a layer thickness of 2 to 20 cm. The polymerization gives rise to a solid gel. The polymerization can also be effected continuously. For this purpose, a polymerization apparatus is used, which possesses a conveyor belt to accommodate the mixture to be polymerized. The conveyor belt is equipped with devices for heating and/or for irradiating with UV radiation. In this method, the mixture is poured onto one end of the belt by means of a suitable apparatus, the mixture is polymerized in the course of transport in belt direction, and the solid gel can be removed at the other end of the belt.

The gel obtained is preferably comminuted and dried after the polymerization. The drying should preferably be effected at temperatures below 100° C. To prevent conglutination, it is possible to use a suitable separating agent for this step. This gives the hydrophobically associating copolymer as granules or powder.

Further details of the performance of a gel polymerization are disclosed, for example in DE 10 2004 032 304 A1, paragraphs [0037] to [0041].

Since the polymer powder or granules obtained are generally used in the form of an aqueous solution in the course of application at the site of use, the polymer has to be dissolved in water on site. This may result in undesired lumps with the high molecular weight polymers described. In order to avoid this, it is possible to add an assistant which accelerates or improves the dissolution of the dried polymer in water to the inventive polymers as early as in the course of synthesis. This assistant may, for example, be urea.

### Properties of the Copolymers

The resulting copolymers preferably have a weight-average molecular weight M_{W} of 1*10⁶ g/mol to 30*10⁶ g/mol, preferably 5*10⁶ g/mol to 20*10⁶ g/mol.

For the process, preference is given to using those copolymers which are notable for particularly low shear degradation.

The term “shear degradation” is defined as the percentage permanent alteration in the viscosity of a polymer solution after shearing of the polymer solution under particular conditions. “Permanent” means that the viscosity loss is maintained even after the shear stress ceases, and is not reversible as is the case with structurally viscous (shear-diluting) behavior when the shear stress ceases.

Shear degradation of high molecular weight solutions of polymers may arise when the mechanical stress on the polymer solutions due to shear is great enough to be able to cause breaking of polymer chains (see, for example, J. M. Maerker, Shear Degradation of partially hydrolyzes polyacrylamide solutions”, SPE Journal 15(4), 1975, pages 311-322 or R. S. Seright, “The effects of mechanical degradation and viscoelastic behavior on injectivity of polyacrylamide solutions”, SPE Journal 23(3), 1983, pages 475-485). As a result of this, the proportion of long polymer chains in the polymer solution is reduced, and the viscosity of the polymer solution accordingly decreases irreversibly.

The shear degradation of polymers can be measured by means of a capillary shear test to API RP 63. For the measurement, a solution of the polymer is pressed through a narrow capillary under pressure. In each case, the viscosity of the polymer solution is determined before and after the pressing through the capillary. The shear stress on the polymer can be adjusted via the pressure with which the solution is pressed through the capillary, length and diameter of the capillary, and viscosity of the polymer solution (i.e. ultimately the concentration of the polymer solution). The details of the performance of the capillary shear test to API RP 63 are given in the examples section for this invention, to which explicit reference is hereby made.

The shear degradation of the copolymers used for the process according to the invention, measured by means of a capillary shear test to API RP 63, under the conditions specified in the examples section is preferably less than 10%, more preferably less than 8%. Due to this preferred property, the amount of the copolymer used can be kept lower than in the case of copolymers which have a higher shear degradation.

In a second aspect, the present invention therefore relates to a hydrophobically associating copolymer of the composition described at the outset, which further features shear degradation measured by means of a capillary shear test to API RP 63 under the conditions specified in the examples section of less than 10%, preferably less than 8%. Preferred compositions and the preparation of the inventive copolymers have likewise already been described.

### Processes for Mineral Oil Production

To execute the process according to the invention, at least one production borehole and at least one injection borehole are sunk into the mineral oil deposit. In general, a deposit is provided with several injection boreholes and with several production boreholes. An aqueous formulation of the copolymer described is injected into the mineral oil deposit through the at least one injection borehole, and mineral oil is withdrawn from the deposit through at least one production borehole. The term “mineral oil” in this context of course does not only mean single-phase oil, but the term also comprises the customary crude oil-water emulsions. As a result of the pressure generated by the formulation injected, known as the “polymer flood”, the mineral oil flows in the direction of the production borehole and is produced via the production borehole.

The porosity (more correctly known as “permeability”) of a mineral oil formation is reported by the person skilled in the art in the unit “darcy” (abbreviated to “D” or “mD” for “millidarcies”) and can be determined from the flow rate of a liquid phase in the mineral oil formation as a function of the pressure differential applied. The flow rate can be determined in core flooding tests with drill cores taken from the formation. Details on this subject can be found, for example, in K. Weggen, G. Pusch, H. Rischmüller in “Oil and Gas”, pages 37 ff., Ulmann's Encyclopedia of Industrial Chemistry, online edition, Wiley-VCH, Weinheim 2010. It is clear to the person skilled in the art that the permeability in a mineral oil deposit need not be homogeneous, but generally has a certain distribution, and the reported permeability of a mineral oil deposit is accordingly an average permeability.

According to the invention, the deposit is one having an average permeability of 10 mD to 4 D, preferably 100 mD to 2 D and more preferably 200 mD to 1 D.

The deposit temperature is 30 to 150° C., preferably 40 to 100° C. and more preferably 50 to 80° C.

To execute the process, an aqueous formulation which comprises, in addition to water, at least the hydrophobically associating copolymer described is used. It is of course also possible to use mixtures of different copolymers.

The formulation can be made up in fresh water, or else in water comprising salts. For example, it is possible to use sea water, or it is possible to use produced formation water, which is reused in this manner. In the case of offshore production platforms, the formulation is generally made up in sea water. In the case of onshore production units, the polymer can advantageously first be dissolved in fresh water, and the resulting solution can be diluted to the desired use concentration with formation water. The formulation can preferably be prepared by initially charging the water, sprinkling in the copolymer as a powder and mixing it with the water.

In addition, the aqueous formulation may of course comprise further components. Examples of further components comprise biocides, stabilizers or inhibitors.

The concentration of the copolymer is fixed such that the aqueous formulation has the desired viscosity for the end use. The viscosity of the formulation should, however, in any case be at least 5 mPas (measured at 25° C. and a shear rate of 7 s⁻¹, preferably at least 10 mPas.

According to the invention, the concentration of the polymer in the formulation is 0.01 to 2% by weight based on the sum of all components of the aqueous formulation. The amount is preferably 0.05 to 0.5% by weight, more preferably 0.04 to 0.2% by weight and, for example, approx. 0.1% by weight.

The injection of the aqueous copolymer formulation can be undertaken by means of customary apparatus. The formulation can be injected into one or more injection boreholes by means of customary pumps. The injection boreholes are typically lined with cemented steel tubes, and the steel tubes including the cement layer are perforated at the desired site. The formulation exits through the perforation from the injection borehole into the mineral oil formation. The pressure applied by means of the pumps, in a manner known in principle, fixes the volume flow of the formulation and hence also the shear stress with which the aqueous formulation enters the formation. The shear stress on entry into the formation can be calculated by the person skilled in the art in a manner known in principle on the basis of the Hagen-Poiseuille law using the area flowed through on entry into the formation, the mean pore radius and the volume flow. The average porosity of the formation can be determined in a manner known in principle by measurements on drill cores. By its nature, the greater the volume flow of aqueous copolymer formulation injected into the formation, the greater the shear stress.

The volume flow in the course of injection and hence the shear rate can be fixed by the person skilled in the art according to the conditions in the formation. According to the invention, the shear rate on entry of the aqueous polymer formulation into the formation is generally at least 30 000 s⁻¹, preferably at least 60 000 s⁻¹ and more preferably at least 90 000 s⁻¹.

The person skilled in the art selects the copolymers for use in accordance with the invention according to the desired properties of the formulation to be injected. The copolymers and preferred copolymers have already been described at the outset. Particular preference is given to using, for the process according to the invention, copolymers which have a shear degradation of less than 10%, preferably less than 8%.

Copolymers particularly preferred for execution of the process comprise monomers (a) of the general formula H₂C═CH—O—(CH₂)_{n′}—O—(—CH₂—CH₂—O—)ₖ—(—CH₂—CH(R⁴)—O—)ₗ—H (Ia) where n′ is 2 to 6, preferably 2 to 4 and more preferably 4. R⁴ in the preferred variant is a hydrocarbyl radical having 3 to 10 carbon atoms, especially an n-propyl radical. In addition, in formula (Ia), k is a number from 20 to 30 and l is a number from 6 to 20, preferably 8 to 18. The amount of the monomers (a) of the formula (Ia) is 0.2 to 5% by weight, preferably 0.5 to 2% by weight. As monomer (b1), the preferred copolymer comprises 40 to 60% by weight of acrylamide and, as monomer (b2), 35 to 55% by weight of a monomer (b2) having sulfo groups, preferably 2-acrylamido-2-methylpropanesulfonic acid or salts thereof.

Further copolymers preferred for execution of the process likewise comprise 0.2 to 5% by weight, preferably 0.5 to 2% by weight, of monomers (a) of the general formula (Ia) and 30 to 40% by weight of acrylamide. They additionally comprise 25 to 35% by weight of at least one monomer (b2) having sulfo groups, preferably 2-acrylamido-2-methylpropanesulfonic acid or salts thereof, and 25 to 35% by weight of at least one cationic monomer having ammonium ions, preferably salts of 3-trimethylammoniopropyl(meth)acrylamides and 2-trimethylammonioethyl (meth)acrylates.

The examples which follow are intended to illustrate the invention in detail:

### Capillary Shear Test to API RP 63

### Measurement Principle

The shear stability or the shear degradation of polymers for tertiary mineral oil production can in principle be measured by means of a core flooding experiment. Owing to the High complexity of a core flooding experiment, the American Petroleum Institute defined a simplified standard test in which the polymer solution is sheared in a capillary, and the viscosity of the solution before and after the shear stress is compared. This test is used in the context of the present invention.

The shear degradation of the copolymers is determined by means of a capillary shear test according to method API RP 63, title “Recommended Practices for Evaluation of Polymers Used in Enhanced Oil Recovery Operation”, chapter 6.6 “Evaluation of shear stability of polymer solutions”, published by the American Petroleum Institute on Jun. 1, 1990.

### Apparatus

The apparatus for measuring shear degradation consists of a steel cylinder with pressurized gas connection (nitrogen) to accommodate the polymer solution to be analyzed, pressure release valve, venting tap and an outlet valve to which capillaries of different diameter can be secured. The steel cylinder can be pressurized from a nitrogen bomb or a pressurized gas line.

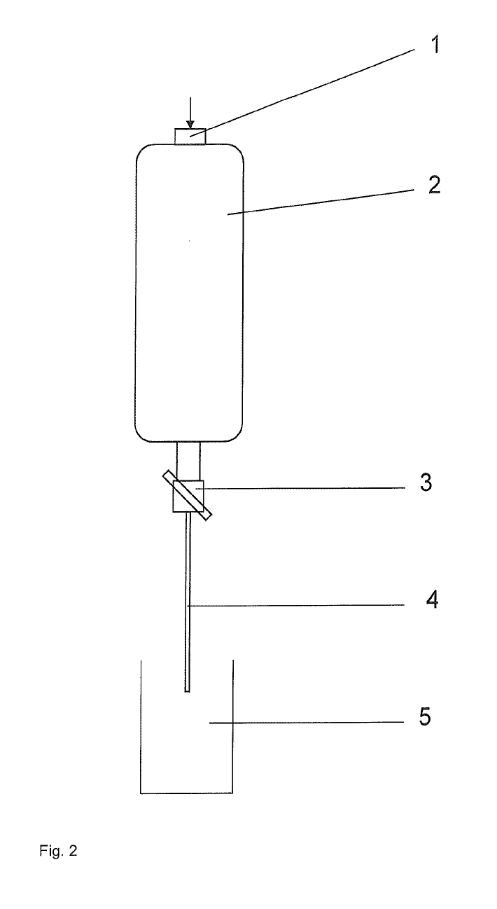

The essential elements of the apparatus used are shown schematically in FIG. 2. It consists of a pressure vessel (2) with a capacity of approx. 1.5 I, which has an outlet valve (3), a gas inlet (1). Below the outlet valve (3) is mounted an exchangeable capillary (4). A receiver vessel (5) serves to receive the polymer solution forced through the capillary. Unless stated otherwise hereinafter, the capillary used for analysis has a length of 200 mm and an internal diameter of 0.6 mm. The gas inlet valve can be screwed off to fill the apparatus with polymer solution.

### Performance of the Analysis

All analyses are undertaken at room temperature.

First, the viscosity of the polymer solution to be analyzed is determined according to the test method below.

The outlet valve (3) of the apparatus used is closed, the apparatus at ambient pressure is filled with the polymer solution to be analyzed (approx. 800 ml) and the apparatus is closed again. The desired analysis pressure is established on the manometer of the nitrogen supply, and the desired analysis pressure is applied to the apparatus. For the analysis, the outlet valve (3) is opened. The polymer solution then flows through the capillary into the collecting vessel (5). Then an analysis vessel is held in the jet of the polymer solution, and approx. 60 to 100 g of the solution are collected: after the collection has ended, the analysis vessel is pulled out again from the jet of the polymer solution. A stopwatch is used to determine the time for collection of the polymer solution, and the mass of the collected polymer solution is determined in each case. This operation is repeated several times, and the corresponding collection times and amounts are determined in each case.

The viscosity of all polymer solutions collected is determined again. The shear degradation is the percentage decrease in the viscosity of the polymer solution after shearing compared to the solution before shearing.

The shear stress is calculated by the following formula:

\dot{γ}=4Q/πR₃
\dot{γ}: apparent shear rate at the capillary wall (without newtonian correction)
Q: flow of the polymer solution in ml/s (the density of the polymer solution can be considered to be 0 as a first approximation, such that the mass also corresponds to the volume).
R: internal diameter of the capillary

The percentage shear degradation is calculated from the measured viscosities η_{before} and η_{after} as follows: (η_{before}−η_{after})/η_{before}

The shear degradation is measured at shear rates \dot{γ} in the range from 80 000 s⁻¹ to 100 000 s⁻¹. Given the same concentration of the polymer solution in a test series, the shear rates can be set within the desired range by altering the pressure.

### Determination of Viscosity

The viscosity measurements were carried out at room temperature with an LVDV-UL Brookfield viscometer at a shear rate of 7 s⁻¹.

### Monomers (a) Used

### Monomer M1

Hydroxybutyl Vinyl Ether Alkoxylate with 22 EO Units and 12 PeO Units

H₂C═CH—O—(CH₂)₄—O—(—CH₂—CH₂—O—)₂₂—(—CH₂—CH(C₃H₇)—O—)₁₂—H

A 1 l stirred stainless steel autoclave is initially charged with 44.1 g of hydroxybutyl vinyl ether. Subsequently, 3.12 g of KOMe (32% in MeOH) are metered in and the methanol is drawn off at 80° C. and approx. 30 mbar. This is followed by heating to 140° C., purging of the reactor with nitrogen and establishment of a nitrogen pressure of 1.0 bar. Then 368 g of ED are metered in within approx. 3 h. After continued reaction at 140° C. for a half hour, the reactor is cooled to 125° C., and a total of 392 g of pentene oxide are metered in over the course of 3.5 h. The reaction continues overnight.

The product has an OH number of 31.9 mg KOH/g (theory: 26.5 mg KOH/g). The OH number is determined by means of the ESA method.

### Monomer M2

Commercially available monomer of the general formula

H₂C═C(CH₃)—COO—(—CH₂—CH₂—O—)₂₅—

R(R=tristyrylphenyl) (Sipomer® SEM 25, from Rhodia).

### Preparation of the Copolymers

### EXAMPLE 1

### Preparation of a Copolymer from 2% by Weight of Monomer M1, 50% by Weight of Acrylamide and 48% by Weight of 2-Acrylamido-2-Methylpropanesulfonic Acid

A plastic bucket with magnetic stirrer, pH meter and thermometer is initially charged with 121.2 g of a 50% aqueous solution of NaATBS (2-acrylamido-2-methylpropanesulfonic acid, sodium salt), and then 155 g of distilled water, 0.6 g of a defoamer (Surfynol® DF-58), 0.2 g of a silicone defoamer (Baysilon® EN), 2.3 g of monomer M1, 114.4 g of a 50% aqueous solution of acrylamide, 1.2 g of pentasodium diethylenetriaminepentaacetate (complexing agent, as a 5% aqueous solution) and 2.4 g of a nonionic surfactant (nonylphenol, alkoxylated with 10 units of ethylene oxide) are added successively.

After adjusting the pH with a 20% or 2% sulfuric acid solution to a value of 6 and adding the rest of the water, the monomer solution is adjusted to the start temperature of 5° C. The total amount of water is such that—after the polymerization—a solids concentration of approx. 30 to 36% by weight is attained. The solution is transferred to a thermos flask, a temperature sensor for the temperature recording is provided and the solution is purged with nitrogen for 30 minutes. The polymerization is then initiated by adding 1.6 ml of a 10% aqueous solution of a water-soluble cationic azo initiator 2,2′-azobis(2-amidinopropane) dihydrochloride (Wako V-50), 0.12 ml of a 1% aqueous solution of tert-butyl hydroperoxide and 0.24 ml of a 1% sodium sulfite solution. After the initiators have been added, the temperature rises to approx. 80° C. within 15 to 30 min. After 30 min, the reaction vessel is placed into a drying cabinet at approx. 80° C. for approx. 2 h to complete the polymerization. The total duration of the polymerization is approx. 2 h to 2.5 h.

A gel block is obtained, which, after the polymerization has ended, is comminuted with the aid of a meat grinder. The gel granules obtained are dried in a fluidized bed dryer at 55° C. for two hours. This gives white, hard granules which are converted to a pulverulent state by means of a centrifugal mill. This gives a copolymer with a weight-average molecular weight of approx. 1*10⁶ g/mol to 30*10⁶ g/mol.

### EXAMPLE 2

### Preparation of a Copolymer from 5% by Weight of Monomer M1, 50% by Weight of Acrylamide and 45% by Weight of 2-Acrylamido-2-Methylpropanesulfonic Acid

The procedure is as in Example 1, except that the amount of monomer M1 is increased from 2% by weight to 5% by weight based on the sum of all monomers, and the amount of 2-acrylamido-2-methylpropanesulfonic acid is reduced from 48% by weight to 45% by weight. The amount of the surfactant (proportions by mass) corresponds to that of monomer M1.

### EXAMPLE 3

### Preparation of a Copolymer from 5% by Weight of Monomer M2, 50% by Weight of Acrylamide and 45% by Weight of 2-Acrylamido-2-Methylpropanesulfonic Acid

The procedure is as in Example 2, except that monomer M2 is used instead of monomer M1 No surfactant is used.

### EXAMPLE 4

### Preparation of a Copolymer from 2% by Weight of Monomer M1, 36% by Weight of Acrylamide and 30% by Weight of 2-Acrylamido-2-Methylpropanesulfonic Acid and 32% by Weight of 3-Trimethylammoniopropylacrylamide Chloride (DIMAPAQUAT)

The procedure is as in Example 1, except that the cationic monomer DIMAPAQUAT (used as a 60% aqueous solution) is additionally used in the amounts specified above. The molar (b2)/(b3) ratio is 0.94.

### EXAMPLE 5

### Preparation of a Copolymer from 3% by Weight of Monomer M2, 35% by Weight of Acrylamide and 30% by Weight of 2-Acrylamido-2-Methylpropanesulfonic Acid and 32% by Weight of 3-Trimethylammoniopropylacrylamide Chloride (DIMAPAQUAT)

The procedure is as in Example 1, except that the monomer M2 and additionally the cationic monomer DIMAPAQUAT (used as a 60% aqueous solution) are used in the amounts specified above.

### Comparative Polymer 1:

This is a commercially available copolymer for polymer flooding, formed from approx. 50% by weight of acrylamide and approx. 50% by weight of 2-acrylamido-2-methylpropanesulfonic acid with a weight-average molecular weight M_{W} of approx. 8 to 13′10⁶ g/mol.

### Comparative Polymer 2:

This is a commercially available copolymer for polymer flooding, formed from approx. 72% by weight of acrylamide and approx. 28% by weight of sodium acrylate units, having a weight-average molecular weight M_{W} of approx. 20 000 000 g/mol.

### Performance Tests

### Shear Stability

Polymer solutions of each of the polymers according to Examples 1 to 5 and Comparative Polymers 1 and 2 were prepared in synthetic sea water (composition: 10 692 ppm Na⁺, 420 ppm K⁺, 1295 ppm Mg^{2+, 422} ppm Ca²⁺, 19 318 ppm Cl⁻, 145 ppm HCO₃⁻, 2697 ppm SO₄²⁻). The concentration of each was such that the shear stress in the capillary shear test was of the same order of magnitude in each case.

First, the viscosity of the solutions was determined, then the capillary shear test was carried out, and the viscosity of the sheared solution obtained was measured once again. This involved carrying out a first viscosity measurement approx. ½ h after the shear stress, and also carrying out another test measurement after 2 days in order to check that the viscosity loss was truly irreversible. Some polymer solutions were sheared for a second time for control purposes after the first shear. All measurements were carried out at room temperature.

In a first test series, measurements were carried out at a shear rate in the range from 80 000 s⁻¹ to 100 000 s⁻¹. In a second test series, measurements were carried out at a shear rate of more than 100 000 s⁻¹.

The test conditions and the results are compiled in Tables 1 and 2.

The examples and comparative examples show that the shear degradation of the copolymers which comprise hydrophobically associating monomers (a) is distinctly less than with the comparative polymers without monomers (a).

Surprisingly, an increase in the viscosity in the course of shear was even observed for some copolymers. Without being tied to a particular theory, we suspect that this effect could be caused by a change in conformation. The polymer solutions which exhibited an increase in viscosity were sheared once again for test purposes thereafter. In the second shear, they exhibit a low shear degradation of distinctly less than 8%.

TABLE 1
Compilation of the results of the shear test at a shear rate in the range from 80 000 s⁻¹ to 100 000 s⁻¹.

| | Monomers (a) | | | Polymer | | | η before | η | | |
|---|---|---|---|---|---|---|---|---|---|---|
| | | Amount | | concentration | Pressure | Shear rate \dot{γ} | shear | after shear | Shear | |
| Polymer | Type | [% by wt.] | Monomers (b) | [ppm] | [bar] | [s⁻¹] | [mPas] | [mPas] | degradation | Comments |
| No. 1 | M1 | 2 | (b1), (b2) | 1400 | 4 | 82 654 | 21.9 | 21.8 | 0.4% | |
| No. 2 | M1 | 5 | (b1), (b2) | 1000 | 4 | 85 865 | 21.6 | 21.5 | 0.5% | |
| No. 3 | M2 | 5 | (b1), (b2) | 3000 | 5 | 86 003 | 24 | 22.3 | 6.9% | |
| No. 3 | M2 | 5 | (b1), (b2) | 3000 | 6 | 99 220 | 24 | 21.6 | 9.9% | |
| No. 4 | M1 | 2 | (b1), (b2), (b3) | 4000 | 4 | 80 922 | 23.9 | 29.5 | −23.2% | Increase in the viscosity! |
| No. 4 | M1 | 2 | (b1), (b2), (b3) | 4000 | 4 | 80 386 | 21 | 20.5 | 2.4% | Second shear |
| No. 5 | M2 | 3 | (b1), (b2), (b3) | 3000 | 5 | 88 549 | 19 | 22.7 | −19.5% | Increase in the viscosity! |
| C1 | — | 0 | (b1), (b2) | 3000 | 8 | 89 990 | 24.8 | 19.9 | 19.8% | |
| C2 | — | 0 | (b1), (b2) | 2000 | 8 | 97 000 | 20 | 15.4 | 23.8% | |

TABLE 2
Compilation of the results of the shear test at a shear rate of more than 100 000 s⁻¹

| | Monomers (a) | | | Polymer | | | η before | η | | |
|---|---|---|---|---|---|---|---|---|---|---|
| | | Amount | | concentration | Pressure | Shear rate \dot{γ} | shear | after shear | Shear | |
| Polymer | Type | [% by wt.] | Monomers (b) | [ppm] | [bar] | [s⁻¹] | [mPas] | [mPas] | degradation | Comments |
| No. 3 | M2 | 5 | (b1), (b2) | 3000 | 8 | 120 103 | 22.8 | 23.8 | −3.9% | Increase in the viscosity! |
| No. 4 | M1 | 2 | (b1), (b2), (b3) | 2500 | 8 | 130 421 | 23.9 | 40 | −65.3% | Increase in the viscosity |
| No. 4 | M1 | 2 | (b1), (b2), (b3) | 2500 | 8 | 132 840 | 40 | 37.2 | 6.0% | Second shear |
| No. 5 | M2 | 3 | (b1), (b2), (b3) | 3000 | 6 | 100 770 | 19 | 21.3 | −12.1% | Increase in the shear |
| No. 5 | M2 | 3 | (b1), (b2), (b3) | 3000 | 8 | 127 388 | 23.9 | 21.8 | 8.7% | |
| No. 5 | M2 | 3 | (b1), (b2), (b3) | 3000 | 8 | 129 414 | 21.8 | 21.6 | 1.3% | Second shear |

1-19. (canceled)

20. A process for mineral oil production, in which an aqueous formulation comprising at least one water-soluble, hydrophobically associating copolymer is injected through at least one injection borehole into a mineral oil deposit having an average permeability of 10 millidarcies to 4 darcies and a formation temperature of 30° C. to 150° C., and crude oil is withdrawn from the deposit through at least one production borehole, wherein
the water-soluble, hydrophobically associating copolymer comprises
(a) 0.1 to 15% by weight of at least one monoethylenically unsaturated, hydrophobically associating monomer (a), and
(b) 85 to 99.9% by weight of at least two monoethylenically unsaturated, hydrophilic monomers (b) different than (a), where the monomers (b) comprise at least
(b1) at least one uncharged, monoethylenically unsaturated, hydrophilic monomer (b1), selected from the group of (meth)acrylamide, N-methyl(meth)acrylamide, N,N′-dimethyl(meth)acrylamide or N-methylol(meth)acrylamide, and
(b2) at least one anionic, monoethylenically unsaturated, hydrophilic monomer (b2) which at least one acidic group selected from the group of —COOH, —SO₃H and —PO₃H₂ and salts thereof,
where the proportions are each based on the total amount of all monomers in the copolymer,
the copolymer has a weight-average molecular weight M_{W} of 1*10⁶ g/mol to 30*10⁶ g/mol,
the amount of the copolymer in the formulation is 0.02 to 2% by weight,
the viscosity of the formulation is at least 5 mPas (measured at 25° C.), and
the aqueous polymer formulation is injected into the formation with a shear rate of at least 30 000 s⁻¹.

21. The process according to claim 20, wherein the average permeability of the formation is 100 millidarcies to 2 darcies.

22. The process according to claim 20, wherein the polymer solution is injected into the formation with a shear rate of at least 60 000 s⁻¹.

23. The process according to claim 20, wherein the shear degradation of the copolymer, measured by means of a capillary shear test to API RP 63, is not more than 10%.

24. The process according to claim 20, wherein the amount of the copolymer in the formulation is 0.05 to 0.5% by weight.

25. The process according to claim 20, wherein the aqueous formulation further comprises salts in an amount of at least 2% by weight.

26. The process according to claim 20, wherein the hydrophobically associating monomers (a) are at least one selected from the group of
H₂C═C(R¹)—R²—O—(—CH₂—CH(R³)—O—)ₖ—(—CH₂—CH(R⁴)—O—)ₗ—R⁵ (I),
H₂C═C(R¹)—O—(—CH₂—CH(R³)—O—)ₖ—R⁶ (II),
H₂C═C(R¹)—(C═O)—O—(—CH₂—CH(R³)—O—)ₖ—R⁶ (III),
where the —(—CH₂—CH(R³)—O—)ₖ and —(—CH₂—CH(R⁴)—O—)ₗ units are arranged in block structure in the sequence shown in formula (I) and the radicals and indices are each defined as follows:
k: a number from 10 to 150,
l: a number from 5 to 25,
R¹: H or methyl,
R²: a single bond or a divalent linking group selected from the group of —(CₙH₂ₙ)— [R^{2a}], —O—(C_{n′}H_{2n′})— [R^{2b}] and —C(O)—O—(C_{n″}H_{2n″})— [R^{2c}], where n, n′ and n″ are each natural numbers from 1 to 6,
R³: each independently H, methyl or ethyl, with the proviso that at least 50 mol % of the R² radicals are H,
R⁴: each independently a hydrocarbyl radical having at least 2 carbon atoms or an ether group of the general formula —CH₂—O—R⁸, where R^{4′} is a hydrocarbyl radical having at least 2 carbon atoms,
R⁵: H or a hydrocarbyl radical having 1 to 30 carbon atoms,
R⁶: an aliphatic and/or aromatic, straight-chain or branched hydrocarbyl radical having 8 to 40 carbon atoms.

27. The process according to claim 26, wherein the hydrophobically associating monomer (a) is at least one of the formula (I), and where
R⁴ is a hydrocarbyl radical having 3 to 8 carbon atoms,
k is a number from 12 to 100, and
R⁵ is H, methyl or ethyl.

28. The process according to claim 27, wherein
R⁴ is an n-propyl radical,
k is from 15 to 80, and
R⁵ is H.

29. The process according to claim 20, wherein the uncharged monomers (b1) are used in an amount of 30 to 95% by weight and the anionic monomers (b2) in an amount of 4.9 to 69.9% by weight, where the amounts are each based on the total amount of all monomers used.

30. The process according to claim 20, wherein the copolymer further comprises at least one monoethylenically unsaturated, cationic monomer (b3) comprising ammonium ions.

31. The process according to claim 30, wherein the cationic monomer (b3) comprises salts of 3-trimethylammoniumpropyl(meth)acrylamides and 2-trimethylammoniumethyl (meth)acrylates.

32. The process according to claim 30, wherein the uncharged monomers (b1) are used in an amount of 30 to 95% by weight and the anionic monomers (b2) and cationic monomers (b3) together in an amount of 4.9 to 69.9% by weight, with the proviso that the molar (b2)/(b3) ratio is 0.7 to 1.3, and where the amounts are each based on the total amount of all monomers used.

33. The process according to claim 20, wherein the amount of monomers (a) is 0.2 to 5% by weight.

34. The process according to claim 20, wherein the preparation of the hydrophobically associating copolymer is undertaken in the presence of a nonpolymerizable, surface-active compound.

35. A water-soluble, hydrophobically associating copolymer having a weight-average molecular weight M_{W} of 1*10⁶ g/mol to 30*10⁶ g/mol, comprising at least
(a) 0.1 to 15% by weight of at least one monoethylenically unsaturated, hydrophobically associating monomer (a), and
(b) 85 to 99.9% by weight of at least one monoethylenically unsaturated, hydrophilic monomer (b) different than (a), where the monomers (b) comprise at least
(b1) at least one uncharged, monoethylenically unsaturated, hydrophilic monomer (b1), selected from the group of (meth)acrylamide, N-methyl(meth)acrylamide, N,N′-dimethyl(meth)acrylamide or N-methylol(meth)acrylamide, and
(b2) at least one anionic, monoethylenically unsaturated, hydrophilic monomer (b2) which at least one acidic group selected from the group of —COOH, —SO₃H and —PO₃H₂ and salts thereof,
where the proportions are each based on the total amount of all monomers in the copolymer, wherein the shear degradation of the copolymer, measured by means of a capillary shear test to API RP 63, is not more than 10%.

36. A copolymer according to claim 35, wherein the hydrophobically associating monomer (a) comprises at least one selected from the group of
H₂C═C(R¹)—R²—O—(—CH₂—CH(R³)—O—)ₖ—(—CH₂—CHR⁴—O—)ₗ—R⁵ (I),
H₂C═C(R¹)—O—(—CH₂—CH₂—O—)ₖ—R⁶ (II),
H₂C═C(R¹)—(C═O)—O—(—CH₂—CH₂—O—)ₖ—R⁶ (III),
where the —(—CH₂—CH(R³)—O—)ₖ and —(—CH₂—CH(R⁴)—O—)ₗ units are arranged in block structure in the sequence shown in formula (I) and the radicals and indices are each defined as follows:
k: a number from 10 to 150,
l: a number from 5 to 25,
R¹: H or methyl,
R²: a single bond or a divalent linking group selected from the group of —(CₙH₂ₙ)— [R^{2a}], —O—(C_{n′}H_{2n′})— [R^{2b}] and —C(O)—O—(C_{n″}H_{2n″})— [R^{2c}], where n, n′ and n″ are each natural numbers from 1 to 6,
R³: each independently H, methyl or ethyl, with the proviso that at least 50 mol % of the R² radicals are H,
R⁴: each independently a hydrocarbyl radical having at least 2 carbon atoms or an ether group of the general formula —CH₂—O—R⁸, where R^{8′} is a hydrocarbyl radical having at least 2 carbon atoms,
R⁵: H or a hydrocarbyl radical having 1 to 30 carbon atoms,
R⁶: an aliphatic and/or aromatic, straight-chain or branched hydrocarbyl radical having 8 to 40 carbon atoms.

37. A copolymer according to claim 36, wherein the hydrophobically associating monomer (a) is at least one of the formula (I), and where
R⁴ is a hydrocarbyl radical having 3 to 10 carbon atoms,
k is a number from 12 to 100, and
R⁵ is H, methyl or ethyl.

38. A copolymer according to any of claim 35, wherein the preparation of the copolymer is undertaken in the presence of a nonpolymerizable, surface-active compound.
